(19) United States
(12) Patent Application Publication
(10) Pub. No.: US 2013/0317914 A1
(43) Pub. Date: Nov. 28, 2013

(54) Method and System of advertising using electronic communication

(71) Applicant: Nizar Bhojani, Tampa, FL (US)

(72) Inventor: Nizar Bhojani, Tampa, FL (US)

(21) Appl. No.: 13/478,339

(22) Filed: May 23, 2012

(51) Int. Cl. G06Q 30/02

(52) U.S. Cl. 705/14.66

(57) ABSTRACT

A system and method of advertising using electronic communication, such as SMS or MMS. A website provides consumers the ability to select vendors they are interested in hearing from as well as the products they are interested in. Subscribers will also be able to select the frequency of messages they wish to receive from their chosen vendors. When vendors send out messages about product specials, only ‘matched’ subscribers will receive those messages.

### FIELD OF INVENTION

This invention relates to advertising; more specifically, to advertising using the Internet and electronic communication services, such as short message services (SMS) or Multimedia Messaging Services (MMS).

### SUMMARY

Current mass marketing techniques are unable to zone in on interested customers. Each year, vendors spend millions of dollars on traditional methods of advertising; methods which are untargeted and wasteful. From the consumer's perspective, they have no control over the advertising content they receive, be it on the internet, TV, or direct mail. It is a hassle searching for deals.

Some retailers have leveraged the short message services (SMS) technology by allowing consumers to subscribe to generic deals or specials on their websites, but there are no ‘one-stop-subscription-portals’ currently in the marketplace. The closest related technology would be websites, text messages, or emails that highlight deals or specials. However, with these, consumers have no control over the content, making them undesirable to the consumer.

The present invention connects vendors with consumers through the use of the Internet and electronic communication services, such as SMS or Multimedia Messaging Services (MMS). A web portal will provide consumers the ability to select vendors they are interested in hearing from as well as the products they are interested in purchasing. The system automatically links the subscriber to the vendor(s) chosen or to the vendor(s) offering the categories chosen. Subscribers will also be able to select the frequency of SMSs they wish to receive from their chosen vendors. When vendors send out SMSs about product specials, only ‘matched’ subscribers will receive those SMSs.

The system and method of the present invention will provide consumers control over the content of advertisements they receive. Consumers will only receive content which they have elected to receive. It will also reduce clutter and provide short, targeted messages to subscribers directly from chosen vendors on chosen product categories. For vendors, it will provide a targeted medium of advertising that provides a direct link to consumers while lowering costs.

### BRIEF DESCRIPTION OF THE DRAWINGS

For a fuller understanding of the invention, reference should be made to the following detailed description, taken in connection with the accompanying drawings, in which:

FIG. 1 is a diagram illustrating the retailer and consumer setup features according to an embodiment of the present invention.

FIG. 2 is a diagram illustrating the retailer messaging feature according to an embodiment of the present invention.

FIG. 3A is a flowchart illustrating an exemplary method executed by the system server when matching a subscriber with a vendor according to an embodiment of the present invention.

FIG. 3B is a flowchart illustrating an exemplary method executed by the system server when matching a subscriber with a category according to an embodiment of the present invention.

FIG. 4 is a flowchart illustrating an exemplary method executed by the system server when processing a vendor request to send a message according to an embodiment of the present invention.

### DETAILED DESCRIPTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

Inbound marketing has taken off in recent years as retailers fight over eyeballs. Google adwords and FACEBOOK™ sidebar ads clutter web browsers while marketing emails “spam-bard” consumers. The poor web-surfer has little control over the content he inhales online as marketers invade personal space and individual privacy suffers.

The method and system of the present invention will return to the consumers what is rightfully theirs—control over the content they would like to see. The system and method of the present invention will connect vendors with consumers through the use of the Internet and electronic communication services, such as SMS or Multimedia Messaging Services (MMS). FCC regulations prohibit marketers from targeting cell phones; therefore, unlike email accounts, which can be bombarded with thousands of emails at any time, consumers cannot receive marketing messages on their cell phone unless they so wish. Furthermore, limited space in SMS fields will ensure marketers make the most efficient use of available space with direct, concise advertisements.

The present invention includes a website on which consumers will sign up to receive electronic communication services, such as text messages, from their favorite retailers by simply entering an email address and a telephone number. Not only can they choose which retailer they would like to hear from, but they can also select the types of products they are interested in, and the frequency of SMSs they will receive from any particular retailer. The web portal will be a one-stop shop for the consumers to manage all of their SMS subscriptions.

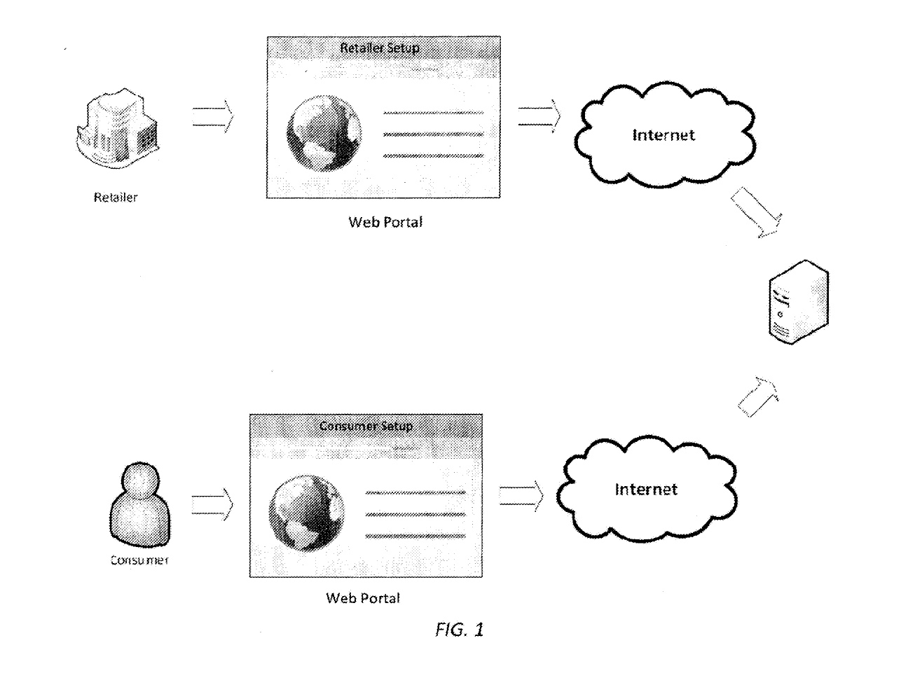

The diagram shown in FIG. 1 illustrates the retailer setup and consumer setup features. For the retailer setup, the retailer enters identifying information such as name and location. The retailer may also select the category(ies) of products available at its store(s) into the web portal. Alternatively, the retailer setup may be done manually into the system at the server (instead of by the retailer through the web portal).

For the consumer setup, the consumer enters identifying information, such as an email address and phone number, into the web portal. Here, the user can also manage the number and frequency of messages received. The consumer is presented with a list of retailers and/or product categories to which he or she can subscribe. The consumer can also customize categories (or form new ones) through a blank textbox provided. The system then automatically links the subscriber to the retailers(s) chosen or to the vendor(s) offering the categories chosen. Subscriber lists are automatically created and subscriber numbers under each list are passed on to the ‘chosen’ vendors (selected by customers when signing up for the service). Categories may range from broad (e.g. “electronics”, “groceries”, “furniture”) to somewhat specific (e.g. “TVs”, “produce”, “bedroom furniture”) to more specific (e.g. “HDTVs”, “bananas”, “beds”) to particular products (e.g. “SAMSUNG™ 40″ 1080p LCD HDTV”, “CHIQUITA® bananas”, “MAINSTAYS™ twin storage bed, cinnamon cherry”). The consumer may also select a minimum and/or maximum price for a particular product or product category. In this manner, the consumer will only receive messages that fall within their price range for a particular product. The consumer is also able to select the number and frequency of messages that he or she receives from each retailer. The selections made by the user at the web portal are then transmitted to the system server. The system server stores the information collected from the consumer.

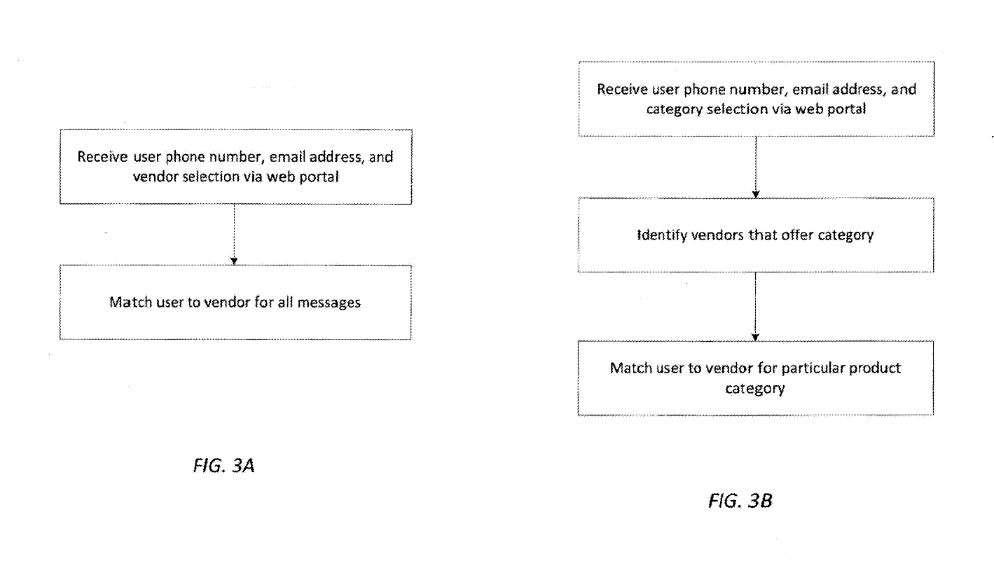

The system server also automatically matches consumer selections according to vendor/category/product availability. For example, if a user has entered his email address and phone number and has selected a vendor on the web portal and submitted the information, as illustrated in the flowchart of FIG. 3A, the system server receives the vendor selection along with the user email and phone number and stores this information. The system then matches the user to the vendor for all messages.

Another example is illustrated in the flowchart of FIG. 3B. Here, the user has entered his email address and phone number and has selected a category on the web portal and submitted the information. The system server receives the category selection along with the user email and phone number and stores this information. The system identifies vendors that offer the category selected by the user. The system then matches the user to the vendor for that particular product category.

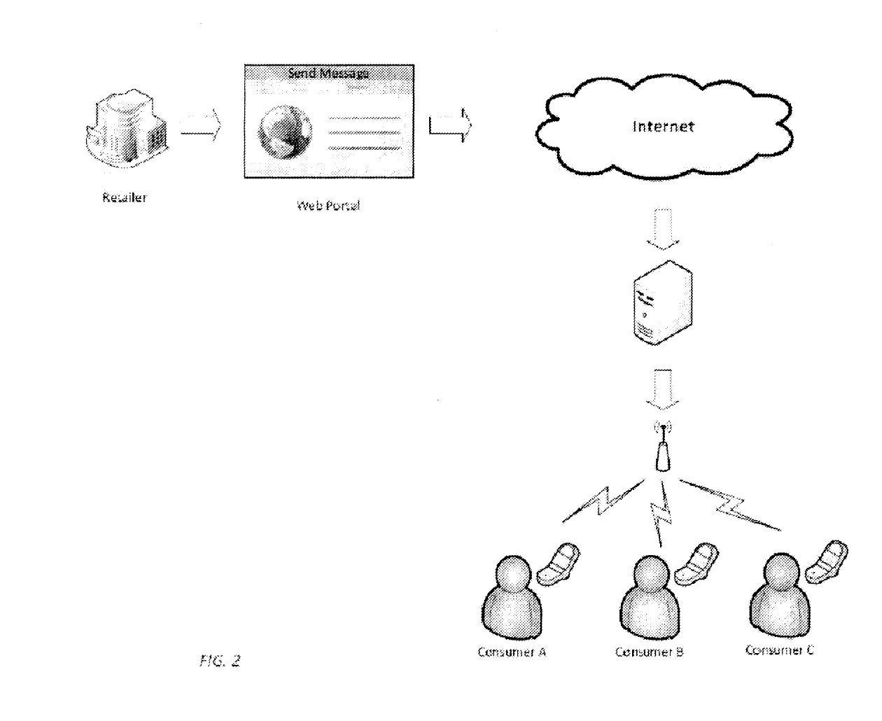

Vendors will send out messages, but only those consumers have chosen to receive messages from vendors and have been matched by the system with vendors will receive the messages. Thus, consumers will avoid clutter by only receiving marketing messages from the vendor(s) they have chosen about the products they are looking for, and vendors will save money by targeting only those consumers who are truly in the market for their products. As shown in FIG. 2, to send a message, a retailer may use a web portal. This web portal allows the retailer to identify the type of message being sent (e.g. “daily deal”, “product special”), include a limited character message to be sent, identify the specific product on special, if applicable, the category the product falls in, if applicable, and any other pertinent information, such as sale price. On the vendor's interface, included along with each category is the number of subscribers that have requested to receive messages pertaining to the category. This provides the vendor with valuable information that allows the vendor to make an informed decision when creating sale specials and sending out messages pertaining to them. No identifying information about the subscriber is shared with the vendor.

Once the vendor creates its limited character message and enters the necessary related information, and submits it, the message and related information are sent, via the Internet, to the system server(s). Here, the message content is checked for quality control. Messages with inappropriate content or content that does not match the type of message specified by the vender or the proper product category will not be sent on to subscribers. Messages that pass the quality control check will be sent on only to those consumers that have subscribed to the retailer/category/products combination that matches the content of the message.

For online vendors, message click-through rates can also be tallied and presented to the vendor in the web portal, which will serve as an indicator to help the vendor to adjust its outgoing messages appeal to consumers.

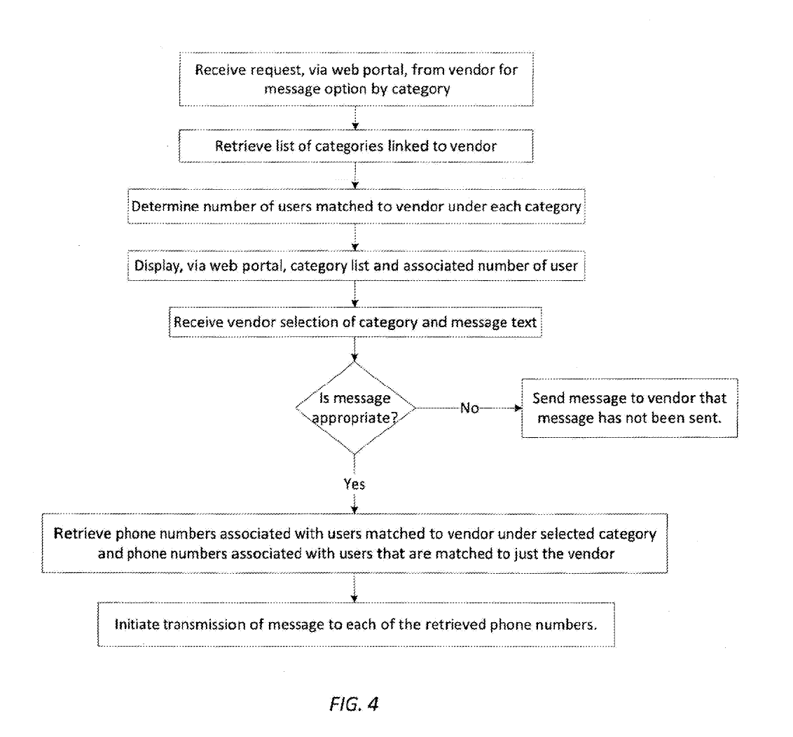

An example method used by the system server to handle vendor requests is shown in the flowchart of FIG. 4. Once a vendor who is already setup on the system logs in to the web portal and selects the option to send a message associated with a category, the web portal will send a request to the server for the vendor's message options. The system server receives the request and retrieves the list of categories linked with the vendor. The system server then determines the number of users matched to the vendor under each category. The server sends the category list and associated number of users for each category to the web portal for display to the user. The vendor can then make a category selection and enter message text at the web portal. This information is then sent back to the system server. Upon receipt of a vendor selection of a category and message text, the system server checks the message text for appropriateness. If the message is found to be inappropriate, the system sends a message back to the web portal for display to the vendor that the message cannot be sent. If the message is found to be appropriate, then the system retrieves the phone numbers associated with each of the users matched to the vendor under the selected category and all of the users that are matched to just the vendor itself. The server then initiates transmission of the message to each of these phone numbers.

### Exemplary Implementation I

### Daily Special From Chosen Vendor(s)

In this example, the messages retailers will send will contain a “daily special”, a one-day deal that the retailer would like to offer subscribers who have signed up for the service. This deal can be an existing deal at the retailer's website (they will need to choose the best one), or it can be a special deal just for members. So, for example, people who live close to PUBLIX® and are interested in a daily special from PUBLIX® would sign up to receive messages from it. PUBLIX® will send out a text daily about what item it has put on special that particular day.

PUBLIX® would like this because it will develop a fan-base that it can constantly communicate with. It can also take advantage of consumers walking in the store to purchase items by hoping to sell more items than what the consumer had initially come in for. The daily special will serve as bait, or a loss leader. At the other end, consumers will wait to hear from PUBLIX® and decide whether or not to go to take advantage of the daily special. If they do not find the daily deal enticing enough, they can choose not to go, but if they feel that the deal fits their needs, they can choose to take advantage of it.

### Exemplary Implementation II

### Product Special From Chosen Vendor(s)

If subscribers have signed up for a particular category of goods from a vendor of their choosing, then they will only receive messages from that vendor when it sends out a message that relates to them. For example, if a customer is interested in HDTV deals from AMAZON®, that customer will only get a text if AMAZON® has sent a message out relating to HDTVs. However, this does not stop AMAZON® to choose different text messages to be sent out to different segments of subscribers. For example, it could send out one for HDTVs and another one for organic groceries; however, the consumer will only receive as many messages as s/he has signed up for. The customer can also select multiple vendors, and s/he then will receive SMSs from all vendors selected.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

What is claimed is:

1. A method of advertising using electronic communication comprising:
receiving a retailer's message;
receiving a consumer's contact information and preferences;
determining if the consumer should receive the retailer's message based on the content of the retailer's message and the consumer's preferences; and
sending the retailer's message to the consumer responsive to a determination that the consumer should receive the message.

2. A system of advertising using electronic communication comprising:
a web portal for receiving a retailer's message and for receiving a consumer's contact information and preferences; and
a server for receiving the retailer's message, determining if the consumer should receive the retailer's message based on the content of the retailer's message and the consumer's preferences, and sending the retailer's message to the consumer responsive to a determination that the consumer should receive the message.
